(19) United States
(12) Patent Application Publication
(10) Pub. No.: US 2022/0290332 A1
(43) Pub. Date: Sep. 15, 2022

(54) FIBER STRUCTURE AND METHOD OF PRODUCING SAME

(71) Applicant: Toray Industries, Inc., Tokyo (JP)

(72) Inventors: Kenichi Harimoto, Otsu-shi, Shiga (JP); Kanta Tanabe, Otsu-shi, Shiga (JP); Hirokazu Sakaguchi, Otsu-shi, Shiga (JP)

(21) Appl. No.: 17/636,691

(22) PCT Filed: Aug. 20, 2020
(86) PCT No.: PCT/JP2020/031416

§ 371 Date: Feb. 18, 2022

(30) Foreign Application Priority Data
Aug. 26, 2019 (JP) 2019-153465

(51) Int. Cl. D01F 6/62; C08L 63/08; C08L 101/16; D01F 6/92; D04H 1/728; D04H 3/011

(52) U.S. Cl. CPC D01F 6/625; C08L 63/08; C08L 101/16; D01F 6/92; D04H 1/728; D04H 3/011

(57) ABSTRACT

A fiber structure includes a biodegradable polymer fiber, the fiber structure having two or more peaks in a molecular weight distribution obtained by GPC measurement of the biodegradable polymer, and the fiber structure having one or more peaks in each of a region of 100,000 or less of molecular weight and a region of more than 100,000 of molecular weight in the molecular weight distribution obtained by GPC measurement of the biodegradable polymer.

### TECHNICAL FIELD

This disclosure relates to a fiber structure and a method of producing the same.

### BACKGROUND

Nonwoven fabrics having a structure in which fibers are three-dimensionally intertwined and porous bodies have voids inside and exhibit substance invasiveness and permeability, and thus have been used for filters, adsorbents, and the like for a long time. In recent years, research on using a nonwoven fabric as a base material of a cell scaffold material (scaffold base material) has also been actively conducted. A nonwoven fabric using a biodegradable material is expected as a scaffold material for transplantation because the nonwoven fabric, which is a scaffold material, is decomposed and replaced with a self-tissue in a tissue regeneration process after cells are engrafted inside the nonwoven fabric by the nonwoven fabric using a biodegradable material.

Regarding production of a nanofiber nonwoven fabric applicable as a scaffold material suitable for angiogenesis, cell adhesion for nerve regeneration, and cell proliferation, a method of producing a blended polymer fiber, the method including producing a polymer fiber by an electrospinning method in which a voltage is applied to a polymer solution and jet of the polymer solution is injected to form a polymer fiber, wherein each of a plurality of types of polymer solutions is injected such that spinning start points of the plurality of types of polymer solutions are the same or close to each other to form a single fiber containing a plurality of types of polymer components (see, for example, Japanese Patent Laid-open Publication No. 2007-186831).

On the other hand, as a material excellent in cell wettability, there has been proposed a porous tissue regenerating base material, which is a laminate of at least two layers including a bioabsorbable material, the porous tissue regenerating base material including at least one extra-fine fiber nonwoven fabric layer, and at least one porous layer having an average pore diameter of 0.1 to 800 μm on a surface of the extra-fine fiber nonwoven fabric layer (see, for example, Japanese Patent Laid-open Publication No. 2018-102652).

Scaffold base materials to be implanted in vivo are required to have high permeability and long in-vivo residual time. The permeability of a nonwoven fabric depends on the fiber diameter. To enhance the permeability, it is effective to increase the fiber diameter. To spin a fiber having a large fiber diameter by an electrospinning method, it is effective to increase the concentration of a resin solution. On the other hand, when the concentration of a resin solution increases, the viscosity increases, and the surface tension becomes stronger than the repulsive force of charges. Therefore, in the method described in JP '831, it is difficult to spin a fiber having a large fiber diameter, and there is a problem that the permeability is insufficient.

In addition, to spin a fiber having the fiber diameter described in JP '652 by the method described in JP '652, it is necessary to use a polymer having a relatively small molecular weight, and the decomposition speed of the resulting porous tissue-regenerating base material is high, therefore there is a problem that the in-vivo residual time is short.

It could therefore be helpful to provide a fiber structure having a high permeability and a long in-vivo residual time.

### SUMMARY

We therefore provide a fiber structure including a biodegradable polymer fiber, the fiber structure having two or more peaks in a molecular weight distribution obtained by GPC measurement of the biodegradable polymer.

A fiber structure having a high permeability and a long in-vivo residual time can be obtained.

### DETAILED DESCRIPTION

Our fiber structure includes a biodegradable polymer fiber.

### Biodegradable Polymer

Examples of the biodegradable polymer include polyglycolic acid, polylactic acid (D, L, DL configuration), polycaprolactone, polyhydroxybutyric acid, polyhydroxybutyrate valeric acid, polyorthoester, polyhydroxyvalerylic acid, polyhydroxyhexanoic acid, polyhydroxy-butanoic acid, polybutylene succinate, polybutylene succinate, polytrimethylene terephthalate, polyhydroxyalkanoate, and copolymers thereof. Two or more kinds thereof may be used. Among the biodegradable polymers, biodegradable polyesters which are easily decomposed into monomers are preferable. Among the biodegradable polyesters, polylactic acid, polycaprolactone, polyglycolic acid, and copolymers thereof, which have abundant clinical results of safety of decomposition products and are likely to secure safety, are more preferable. A dilactide/ε-caprolactone copolymer (copolymer of polylactic acid and polycaprolactone) whose synthesis method is simple is further preferable.

The maximum point stress of the biodegradable polymer is preferably 1 MPa to 1000 MPa at which the maximum point stress is about the same as that of a biological tissue, and more preferably 5 MPa to 30 MPa from the viewpoint of preventing yarn breakage during spinning. The Young's modulus of the biodegradable polymer is preferably 0.1 MPa to 1000 MPa, at which the Young's modulus is about the same as that of a biological tissue, and is preferably 1.0 MPa to 6.3 MPa from the viewpoint of easily spinning a fiber having a larger fiber diameter.

The maximum point stress and Young's modulus of the biodegradable polymer can be measured by a method defined in JIS K6251 (2010). Specifically, a solution obtained by drying a biodegradable polymer under reduced pressure and dissolving the polymer in chloroform to have a concentration of 5 weight % is transferred onto a petri dish made of “TEFLON” (registered trademark) and dried at normal pressure and room temperature for a whole day and night. A polymer film having a thickness of 0.1 mm obtained by drying the resulting material under reduced pressure is cut into a strip shape (30 mm×5 mm), and a tensile test is performed using a small desktop tester EZ-LX (manufactured by Shimadzu Corporation) under the conditions of an initial length of 10 mm, a tensile speed of 500 mm/min, and a load cell of 50N to measure a maximum point stress and a Young's modulus. The maximum point stress and the Young's modulus of the biodegradable polymer can be determined by performing the measurement three times for each and calculating the number average value.

### Polylactic Acid

Polylactic acid is a polymer or copolymer of lactic acid such as _{L}-lactic acid and _{D}-lactic acid. A homopolymer of _{L}-lactic acid is preferable from the viewpoint of physical properties and biocompatibility.

### Method of Producing Polylactic Acid

Polylactic acid can be synthesized, for example, by ring-opening polymerization of dilactide. Dilactide means a dimer of lactic acid. One example of a method of synthesizing polylactic acid using _{L}-dilactide will be described.

First, _{L}-dilactide and a co-initiator are collected in a separable flask. Examples of the co-initiator include lauryl alcohol.

Next, a catalyst is added under a nitrogen atmosphere, and stirring is performed while heating the raw materials to uniformly dissolve or melt the raw materials. Examples of the catalyst include tin(II) octylate. The dissolution or melting temperature is preferably 95° C. or more from the viewpoint of uniformly dissolving or melting the raw materials and, on the other hand, is preferably 110° C. or less from the viewpoint of suppressing excessive reaction. The stirring speed is preferably 80 rpm to 200 rpm. The dissolution or melting time is preferably 10 minutes to 60 minutes.

After dissolution or melting, stirring is performed while further heating to react the raw materials. The reaction temperature is preferably 120° C. or more from the viewpoint of suppressing precipitation of the raw materials, and on the other hand, is preferably 140° C. or less from the viewpoint of suppressing volatilization of the raw materials. The stirring speed is preferably 80 rpm to 200 rpm. The reaction time is preferably 12 hours to 48 hours. Thereafter, the inside of the flask is brought into a reduced pressure state while maintaining the temperature, and unreacted _{L}-dilactide is removed. Finally, the reaction mixture is dissolved in chloroform or the like and added dropwise to stirred methanol to precipitate polylactic acid. The stirring speed of methanol is preferably 200 rpm to 300 rpm. To remove the solvent in the obtained polylactic acid, drying is preferably performed. The drying time is preferably 12 hours or more.

### Polycaprolactone

Polycaprolactone is a copolymer of ε-caprolactone.

### Method of Producing Polycaprolactone

Polycaprolactone can be synthesized, for example, by ring-opening polymerization of ε-caprolactone. One example of a method of synthesizing polycaprolactone using ε-caprolactone will be described.

First, ε-caprolactone and a co-initiator are collected in a separable flask. Examples of the co-initiator include 1,4-butanediol.

Next, a catalyst is added under a nitrogen atmosphere, and stirring is performed while heating the raw materials to react the raw materials. Examples of the catalyst include tin(II) octylate. The reaction temperature is preferably 110° C. or more from the viewpoint of enhancing the reactivity and, on the other hand, is preferably 250° C. or less from the viewpoint of suppressing volatilization of the raw materials. The stirring speed is preferably 80 rpm to 200 rpm. The reaction time is preferably 6 hours to 48 hours.

Thereafter, the reaction mixture is dissolved in chloroform or the like and added dropwise to stirred methanol to precipitate polycaprolactone. The stirring speed of methanol is preferably 200 rpm to 300 rpm. To remove the solvent in the obtained polycaprolactone, drying is preferably performed. The drying time is preferably 12 hours or more.

### Polyglycolic Acid

Polyglycolic acid is a copolymer of glycolic acid.

### Method of Producing Polyglycolic Acid

Polyglycolic acid can be synthesized, for example, by ring-opening polymerization of glycolide which is a cyclic diester of glycolic acid. One example of a method of synthesizing polyglycolic acid will be described.

First, glycolide is collected in a round bottom flask. Next, a catalyst is added under a nitrogen atmosphere, and stirring is performed while heating the raw materials to react the raw materials. Examples of the catalyst include tin(II) 2-ethylhexanoate. The reaction temperature is preferably 190° C. or more from the viewpoint of enhancing the reactivity. The stirring speed is preferably 80 rpm to 200 rpm. The reaction time is preferably 2 hours to 12 hours. The mixture is further heated, and stirring is continued. The reaction temperature is preferably 220° C. or more from the viewpoint of enhancing the reactivity, and is preferably 300° C. or less from the viewpoint of preventing volatilization of the raw materials. The stirring speed is preferably 80 rpm to 200 rpm. The reaction time is preferably 15 minutes to 1 hour.

Thereafter, the reaction mixture is dissolved in chloroform or the like and added dropwise to stirred methanol to precipitate polyglycolic acid. The stirring speed of methanol is preferably 200 rpm to 300 rpm. To remove the solvent in the obtained polyglycolic acid, drying is preferably performed. The drying time is preferably 12 hours or more.

### Dilactide/Glycolic Acid Copolymer

The dilactide/glycolic acid copolymer can be synthesized by ring-opening polymerization of lactide and glycolide. One example of a method of synthesizing a dilactide/glycolic acid copolymer will be described.

First, a vertical reaction tube was aerated with dry nitrogen to remove oxygen from the reaction tube. The flow rate of dry nitrogen is preferably 150 mL/min or more. Dilactide and glycolic acid were placed in the reaction tube, and were heated and reacted. The reaction temperature is preferably 180° C. or more from the viewpoint of increasing the reaction speed. The reaction time is preferably 4 hours to 24 hours.

Thereafter, the reaction mixture is dissolved in chloroform or the like and added dropwise to stirred methanol to precipitate a dilactide/glycolic acid copolymer. The stirring speed of methanol is preferably 200 rpm to 300 rpm. To remove the solvent in the obtained dilactide/glycolic acid copolymer, drying is preferably performed. The drying time is preferably 12 hours or more.

### Dilactide/ε-Caprolactone Copolymer

The dilactide/ε-caprolactone copolymer preferably satisfies (1) and (2). By satisfying (1) and (2), an increase in viscosity when the copolymer is dissolved in a solvent at a high concentration can be suppressed, and a fiber having a larger fiber diameter can be easily spun in the method of producing a biodegradable polymer fiber described later. Such a dilactide/ε-caprolactone copolymer can be obtained, for example, by the method of producing a dilactide/ε-caprolactone copolymer including a multimerization step described later.
(1) An R value represented by equation (I) is 0.45 to 0.99:

R=[AB]/2[A][B]×100 (I)
[A]: mole fraction (%) of dilactide residues in the dilactide/ε-caprolactone copolymer
[B]: mole fraction (%) of ε-caprolactone residues in the dilactide/ε-caprolactone copolymer
[AB]: mole fraction (%) of structure in which the dilactide residues and the ε-caprolactone residues are adjacent (A-B and B-A) in the dilactide/ε-caprolactone copolymer.
(2) The crystallization rate of at least either one of the dilactide residues and the ε-caprolactone residues is less than 14%.

The R value is used as an index indicating the randomness of the sequence of monomer residues in the dilactide/ε-caprolactone copolymer. For example, the R value of a random copolymer having a completely random monomer sequence is 1. When the R value is 0.45 or more, crystallinity is low and flexibility is excellent. The R value is preferably 0.50 or more. On the other hand, when the R value is 0.99 or less, adhesiveness can be suppressed. The R value is preferably 0.80 or less.

The R value can be determined by quantifying the ratio of a combination of two adjacent monomers (A-A, B-B, A-B, B-A) by nuclear magnetic resonance (NMR) measurement. Specifically, the dilactide/ε-caprolactone copolymer is dissolved in deuterated chloroform, and the ratio between the dilactide residues and the ε-caprolactone residues in the dilactide/ε-caprolactone copolymer is calculated by ¹H-NMR analysis. In addition, by ¹H homospin decoupling method, for methine group of dilactide (around 5.10 ppm), an α-methylene group of ε-caprolactone (around 2.35 ppm), and an ε-methylene group (around 4.10 ppm), adjacent monomer residues are separated by a signal derived from the lactide or ε-caprolactone and each peak area is quantified. From each area ratio, [AB] of the equation 1 is calculated to obtain the R value. [AB] is a mole fraction of a structure in which dilactide residues and ε-caprolactone residues are adjacent, and specifically, it is a ratio of the number of A-B and B-A to the total number of A-A, A-B, B-A, and B-B.

It is known that the crystallinity of a polymer has a great influence on its mechanical strength. In general, because a low crystalline polymer exhibits a low Young's modulus, it is desirable that the crystallinity is low to obtain flexibility. The crystallization rate of at least either one of the dilactide residues and the ε-caprolactone residues is preferably less than 14%. When the crystallization rate is less than 14%, the Young's modulus is suppressed, and a polyester copolymer suitable for medical materials and elastomer applications can be obtained. The crystallization rate of the dilactide residues is preferably less than 14%. The crystallization rate of the dilactide residues is more preferably 10% or less.

The crystallization rate of the monomer residue refers to a ratio of heat of fusion per unit weight of the monomer residues in the dilactide/ε-caprolactone copolymer to the product of heat of fusion per unit weight of a homopolymer consisting only of certain monomer residues and a weight fraction of the monomer residues in the dilactide/ε-caprolactone copolymer. That is, the crystallization rate of the dilactide residues refers to a ratio of heat of fusion per unit weight of the dilactide residues in the dilactide/ε-caprolactone copolymer to the product of heat of fusion per unit weight of a homopolymer consisting only of dilactide and a weight fraction of the dilactide residues in the dilactide/ε-caprolactone copolymer. The crystallization rates of the dilactide residue and the ε-caprolactone residue respectively indicate ratios of forming a crystal structure in the dilactide residue and in the ε-caprolactone residue of the dilactide/ε-caprolactone copolymer. The crystallization rate can be measured by a DSC method using a differential scanning calorimeter.

The dilactide/ε-caprolactone copolymer may be linear or branched.

The maximum point stress and Young's modulus of the dilactide/ε-caprolactone copolymer can be easily adjusted to fall within the above-described preferable ranges by the production method including a multimerization step described later.

### Method of Producing Dilactide/ε-Caprolactone Copolymer

As one example, the dilactide/ε-caprolactone copolymer may be obtained by a production method including: a macromer synthesis step of blending and polymerizing dilactide and ε-caprolactone such that the sum of dilactide residues and ε-caprolactone residues is 50 mol % or more of all residues and the dilactide residues and the ε-caprolactone residues are each 20 mol % or more of all residues at the completion of polymerization; and
a multimerization step of connecting the macromers obtained in the macromer synthesis step or further adding dilactide and ε-caprolactone to the macromer solution obtained in the macromer synthesis step to multimerize the macromers.

### Macromer Synthesis Step

In the macromer synthesis step, dilactide and ε-caprolactone are blended and polymerized such that the sum of dilactide residues and ε-caprolactone residues is 50 mol % or more of all residues and the dilactide residues and the ε-caprolactone residues are each 20 mol % or more of all residues at the completion of polymerization in theory. As a result, a dilactide/ε-caprolactone copolymer having a dilactide residue and an ε-caprolactone residue as main structural units is obtained. The dilactide/ε-caprolactone copolymer obtained by the step is referred to as “macromer” because the multimerization step described later is further performed in our production method.

The randomness of the distribution of the monomer residues constituting the dilactide/ε-caprolactone copolymer varies depending on the difference in reactivity of the monomers during polymerization. That is, during polymerization, after one monomer of dilactide and caprolactone, when a same monomer or the other monomer is bonded to the one monomer with the same probability, a random copolymer in which monomer residues are completely randomly distributed is obtained. However, when either one of the monomers tends to be easily bonded after one monomer, a gradient copolymer having a biased distribution of monomer residues is obtained. In the obtained gradient copolymer, the composition of monomer residues continuously changes from the polymerization initiation end to the polymerization termination end along the molecular chain.

The reactivity between dilactide and ε-caprolactone is greatly different as described in D. W. Grijpma et al. Polymer Bulletin 25, 335, 341, and dilactide has a higher initial polymerization speed than ε-caprolactone. The initial polymerization speed VA of dilactide is 3.6%/h in terms of reaction rate (%), and the initial polymerization speed VB of ε-caprolactone is 0.88%/h. When dilactide and ε-caprolactone are copolymerized in the macromer synthesis step, dilactide is easily bonded after dilactide. Therefore, in the synthesized macromer, a gradient structure in which the proportion of the dilactide unit gradually decreases from the polymerization initiation end to the polymerization termination end is formed. That is, the macromer obtained in this step becomes a macromer having a gradient structure in which the dilactide residues and the ε-caprolactone residues form a composition gradient in a skeleton due to the initial polymerization speed difference between dilactide and ε-caprolactone. Such a macromer may be referred to as “gradient macromer.”

In the macromer synthesis step, to realize such a gradient structure, it is desirable to synthesize the macromer by a polymerization reaction occurring in one direction from the initiation end. Preferable examples of such a synthesis reaction to be used include ring-opening polymerization and living polymerization.

An example of a method of synthesizing a lactide/caprolactone macromer will be described more specifically. First, dilactide, ε-caprolactone, and a catalyst are placed in a reaction vessel equipped with a stirrer, and stirred while being heated under a nitrogen stream. To remove moisture in the reaction vessel, it is preferable to heat and stir the mixture with the pressure in the reaction vessel being reduced.

As the stirrer, a stirrer equipped with a propeller-type stirring blade is preferable, and the rotation speed of the stirring blade is preferably 50 rpm to 200 rpm.

The heating temperature of the polymerization reaction is preferably 100° C. to 250° C. The reaction time of the polymerization reaction is preferably 3 hours or more, more preferably 5 hours or more, and further preferably 7 hours or more from the viewpoint of increasing the polymerization degree. On the other hand, the reaction time of the polymerization reaction is preferably 24 hours or less from the viewpoint of further improving productivity.

It is preferable that dilactide and ε-caprolactone are used after being purified in advance to remove impurities.

Examples of the catalyst include tin octylate, antimony trifluoride, zinc powder, dibutyltin oxide, and tin oxalate. Examples of the method of adding the catalyst to the reaction system include a method in which the catalyst is added in a state of being dispersed in the raw material at the time of charging the raw material, and a method in which the catalyst is added in a state of being dispersed in a medium at the time of starting the pressure reduction or immediately before starting the heating in the above-described method. The amount of the catalyst used is preferably 0.01 parts by weight or more, and more preferably 0.04 parts by weight or more in terms of metal atom, with respect to 100 parts by weight of the total of dilactide and ε-caprolactone, from the viewpoint of shortening the reaction time and further improving the productivity. On the other hand, the amount of the catalyst used is preferably 0.5 parts by weight or less in terms of metal atom, with respect to the total amount of dilactide and ε-caprolactone, from the viewpoint of further reducing the amount of metal remaining in the dilactide/ε-caprolactone copolymer.

When water is used as a co-initiator, it is preferable to perform a cocatalyst reaction at around 90° C. prior to the polymerization reaction.

The macromer obtained in the present step has an R value similar to that of the dilactide/ε-caprolactone copolymer described in the above (1), that is, the R value represented by equation (I) below:

R=[AB]/(2[A][B])×100 (I)
[A]: mole fraction (%) of dilactide residues in the macromer;
[B]: mole fraction (%) of ε-caprolactone residues in the macromer; and
[AB]: mole fraction (%) of a structure in which the dilactide residues and the ε-caprolactone residues are adjacent (A-B and B-A) in the macromer,
   is preferably 0.45 to 0.99 and more preferably 0.50 to 0.80, to facilitate the production of the dilactide/ε-caprolactone copolymer that finally satisfies the R value shown in the above (1).

Similarly, the macromer obtained in this step has the crystallization rate of the monomer residue described in the above (2), that is, the crystallization rate of at least either one of the dilactide residues and the ε-caprolactone residues is preferably less than 14%, more preferably 10% or less, further preferably 5% or less, and most preferably 1% or less, to facilitate the production of the dilactide/ε-caprolactone copolymer that finally has the crystallization rate of the dilactide residues or the ε-caprolactone residues shown in the above (2).

The weight average molecular weight of the macromer synthesized in the macromer synthesis step is preferably 10,000 or more, and more preferably 20,000 or more. To further reduce the crystallinity and further improve the flexibility, it is preferably 150,000 or less, and more preferably 100,000 or less.

### Multimerization Step

In the multimerization step, the macromers obtained in the macromer synthesis step are connected to each other, or dilactide and caprolactone are further added to the macromer solution obtained in the macromer synthesis step to perform multimerization. In this step, the macromers obtained in one macromer synthesis step may be connected to each other, or a plurality of macromers obtained in two or more macromer synthesis steps may be connected to each other. “Multimerization” means forming a structure in which a plurality of molecular chains having a gradient structure in which the dilactide residues and the caprolactone residues form a composition gradient in a skeleton are repeated by any one of these methods.

The reaction temperature of the condensation reaction in the multimerization step is preferably 20° C. or more from the viewpoint of efficiently advancing the condensation reaction. On the other hand, the reaction temperature of the condensation reaction is preferably 50° C. or less from the viewpoint of suppressing volatilization of the solvent. The reaction time of the condensation reaction is preferably 15 hours or more from the viewpoint of setting the number of macromer units to be multimerized to be in the above-described preferable range. On the other hand, the reaction time of the condensation reaction is preferably 24 hours or less from the viewpoint of narrowing the molecular weight distribution.

When producing a linear dilactide/ε-caprolactone copolymer, for example, it may be synthesized by bonding one molecule of the same gradient macromer to both ends of the gradient macromer via the ends of the macromers.

When the gradient macromer has a hydroxyl group and a carboxyl group at each end, a multimerized dilactide/ε-caprolactone copolymer can be obtained by condensing the ends with a condensing agent. Examples of the condensing agent include 4,4-dimethylaminopyridinium p-toluenesulfonate, N,N′-dicyclohexylcarbodiimide, N,N′-diisopropylcarbodiimide, and N,N′-carbonyldiimidazole. Two or more kinds thereof may be used.

When the polymerization reaction has living characteristics, that is, when the polymerization reaction can start continuously from an end of the polymer, multimerization can be achieved by repeating an operation of further adding dilactide and ε-caprolactone to the gradient macromer solution after the polymerization reaction is completed.

Alternatively, the gradient macromers may be multimerized via a linker as long as the dynamic characteristics of the polymer are not affected. In particular, when a linker having a plurality of carboxyl groups and/or a plurality of hydroxy groups, for example, 2,2-bis(hydroxymethyl)propionic acid is used, a branched polyester copolymer in which the linker is a branch point can be synthesized.

The dilactide/ε-caprolactone copolymer obtained by the production method as described above is a copolymer having a structure in which two or more macromer units where the dilactide residues and the caprolactone residues have a composition gradient in a skeleton are connected, and this is a preferred example of the dilactide/ε-caprolactone copolymer. Such a structure may be referred to as “multi-gradient” for convenience, and a copolymer having the multi-gradient structure may be referred to as “multi-gradient copolymer.” The multi-gradient copolymer preferably has a structure in which two or more macromer units having a gradient structure in which the dilactide residues and the ε-caprolactone residues form a composition gradient in a skeleton are connected, and preferably has a structure in which three or more of the macromer units are connected.

### Biodegradable Polymer Fiber

The biodegradable polymer fiber is a fiber formed from a biodegradable polymer, and has two or more peaks in a molecular weight distribution obtained by GPC measurement of the biodegradable polymer. Having two or more peaks means containing biodegradable polymers having different molecular weights, and contains a biodegradable polymer having a relatively large molecular weight (high molecular weight biodegradable polymer) having a peak on the high molecular weight side and a biodegradable polymer having a relatively small molecular weight (low molecular weight biodegradable polymer) having a peak on the low molecular weight side.

The larger the molecular weight of the biodegradable polymer, the longer the in-vivo residual time of the fiber structure can be. In addition, as the molecular weight of the biodegradable polymer becomes smaller, a biodegradable polymer solution having a relatively low viscosity and a high concentration can be obtained, which allows a fiber having a large fiber diameter to be spun by the electrospinning method, and the permeability of the fiber structure body to improve. That is, by containing biodegradable polymers having different molecular weights, the biodegradable polymer having a relatively large molecular weight (high molecular weight biodegradable polymer) can increase the in-vivo residual time of the fiber structure, and the biodegradable polymer having a relatively small molecular weight (low molecular weight biodegradable polymer) can improve the permeability of the fiber structure. In the molecular weight distribution, as the biodegradable polymers having two or more peaks, the same type of biodegradable polymers having different molecular weights may be used, or different types of biodegradable polymers having different molecular weights may be used.

The ratio between the high molecular weight biodegradable polymer and the low molecular weight biodegradable polymer is preferably 1:2 to 2:1. The ratio between the high molecular weight biodegradable polymer and the low molecular weight biodegradable polymer is the ratio of the polymer weights, and can be calculated by the area ratio between the differential molecular weight distribution curve on the high molecular weight side and the differential molecular weight distribution curve on the low molecular weight side measured before mixing or obtained by GPC measurement described later.

The biodegradable polymer preferably has one or more peaks in each of a region of 100,000 or less of molecular weight and a region of more than 100,000 of molecular weight. By having a peak in a region of 100,000 or less of molecular weight, a fiber having a larger fiber diameter can be spun, and the permeability of the fiber structure body can further improve. The low molecular weight biodegradable polymer preferably has a peak in a region of 100 to 70,000 of molecular weight, and more preferably has a peak in a region of 1,000 to 70,000 of molecular weight. On the other hand, by having a peak in a region of more than 100,000 of molecular weight, the in-vivo residual time of the fiber structure body can be longer. The high molecular weight biodegradable polymer more preferably has a peak in a region of 200,000 or more of molecular weight. The peak in the molecular weight distribution of the biodegradable polymer refers to the maximum value of a differential molecular weight distribution curve obtained by GPC measurement.

The GPC measurement can be performed under the following conditions:
Device name: Prominence (manufactured by Shimadzu Corporation)
Mobile phase: chloroform (for HPLC) (manufactured by Wako Pure Chemical Industries, Ltd.)
Flow rate: 1 mL/min
Column: TSKgel GMHHR-M (φ7.8 mm×300 mm; manufactured by Tosoh Corporation)
Guard column: TSKgel guardcolumn HHR-H (φ6.0 mm×40 mm; manufactured by Tosoh Corporation)
Detector: UV (254 nm), RI
Column, detector temperature: 35° C.
Reference material: polystyrene.

The fiber diameter of the biodegradable polymer fiber is preferably 3 μm or more. When the fiber diameter is 3 μm or more, the permeability of the fiber structure body can further improve. The fiber diameter is more preferably 5 μm or more. The fiber diameter of the biodegradable polymer fiber refers to the average value of the diameters of 20 fibers, and can be determined by enlarging and observing the surface of the fiber structure at a magnification of 500 times using a microscope, and calculating the average value of the fiber diameters measured by distance measurement between two points for 20 biodegradable polymer fibers randomly selected from the observation image. The fiber diameter of the biodegradable polymer fiber can be adjusted to fall within a desired range by, for example, the molecular weight of the biodegradable polymer used in the method of producing a biodegradable polymer fiber described later, the concentration of the biodegradable polymer solution, the spinning speed and the like.

### Method of Producing Biodegradable Polymer Fiber

The biodegradable polymer fiber can be produced, for example, from a biodegradable polymer having the above-described molecular weight distribution, by an electrospinning method. More specifically, solvent spinning may be performed by injecting a solution in which a biodegradable polymer having the above-described molecular weight distribution is dissolved in a solvent, or melt spinning may be performed by melting and injecting a biodegradable polymer having the above-described molecular weight distribution. Because it is possible to increase the fiber diameter, a more remarkable effect is exerted in solvent spinning in which the fiber diameter tends to decrease by volatilization of the solvent. Therefore, it is preferable to form a fiber from a solution of the biodegradable polymer having the above-described molecular weight distribution by an electrospinning method.

As described above, the fiber diameter of the biodegradable polymer fiber depends on the biodegradable polymer concentration, and when the concentration is high, the fiber diameter can be thicker. The biodegradable polymer concentration is preferably 0.25 g/mL or more. On the other hand, the biodegradable polymer concentration is preferably 1.0 g/mL or less from the viewpoint of suppressing an excessive increase in viscosity.

As described above, the fiber diameter of the biodegradable polymer fiber depends on the spinning speed, and when the spinning speed is high, that is, when the amount of the biodegradable polymer solution to be injected is large, the fiber diameter can be thicker. The injection speed is preferably 0.5 mL/hour or more, and more preferably 0.8 mL/hour or more from the viewpoint of suppressing yarn breakage. On the other hand, the injection layering degree is preferably 5 mL/hour or less from the viewpoint of suppressing charge repulsion by appropriately suppressing the amount of the biodegradable polymer solution to be injected at a time.

### Fiber Structure

The fiber structure includes the biodegradable polymer fiber described above. Examples of the structure of the fiber structure include knitting, weaving, orientation, nonwoven fabric-like and the like. Among them, a nonwoven fabric-like structure is preferable. In the nonwoven fabric-like structure, because the fibers are three-dimensionally and irregularly intertwined with each other, the number of voids increases, and the effect of improving the permeability by increasing the fiber diameter is more remarkably exhibited.

In the fiber structure, it is preferable that the permeation resistance of serum proteins to be an index representing permeability is small. The permeation resistance of the fiber structure can be determined by the following method. First, 100 μL of fetal bovine serum is added to an inner side of the fiber structure, and 1 mL of phosphate buffered saline (PBS) is added to an outer side, and the fiber structure is allowed to stand for 3 hours. Then, the concentration of serum proteins in PBS is measured, and the total amount (Q) (ng) of serum proteins that have permeated the outer side is calculated. From the surface area (S) (mm²) of the fiber structure and the standing time (T) (s), the protein permeation flux (J) (ng/mm²·s) per unit time is calculated by equation (II):

J=Q/(S×T) (II).

The slope of the approximate straight line is calculated from a scatter diagram in which the calculated protein permeation flux (J) is taken as the vertical axis and the thickness (d) (mm) of the fiber structure is taken as the horizontal axis, and the permeation resistance (ng/mm³·s) can be obtained from the absolute value thereof. The permeation resistance may be reduced, for example, by increasing the fiber diameter of the biodegradable polymer fiber that forms the fiber structure.

The thickness of the fiber structure is preferably 100 μm or more, more preferably 200 μm or more from the viewpoint of improving strength. The thickness of the fiber structure can be measured by enlarging and observing a cross section of the fiber structure using a microscope. The thickness of the fiber structure can be adjusted to fall within a desired range by, for example, the spinning time by an electrospinning method.

### Method of Producing Fiber Structure

The fiber structure may be produced, for example, by accumulating injected yarns on a collector in the method of producing a biodegradable polymer fiber described above.

The shape of the collector may be selected according to the shape of the intended fiber structure. For example, when producing a sheet-like fiber structure, a sheet-like fiber structure can be produced by accumulating biodegradable polymer fibers while rotating a roller-type collector and cutting the accumulated biodegradable polymer fibers from one end to the other end in a straight line. From the viewpoint of obtaining a flat sheet-like fiber structure, the diameter of the roller is preferably 100 mm or more. When producing a tubular fiber structure, a tubular fiber structure can be produced by accumulating biodegradable polymer fibers while rotating a cylindrical collector, and then pulling out the collector from the fiber structure.

The rotation speed of the collector is preferably 30 rpm or more from the viewpoint of making the thickness of the fiber structure uniform. On the other hand, the rotation speed of the collector is preferably 1000 rpm or less from the viewpoint of easily increasing the fiber diameter.

The distance between the injection port of the solution and the collector is preferably 13 cm or more from the viewpoint of sufficiently volatilizing the solvent. On the other hand, the distance between the injection port of the solution and the collector is preferably 30 cm or less from the viewpoint of suppressing the elongation of the fibers due to electrostatic force.

### EXAMPLES

Our fiber structures and methods will be specifically described with reference to examples, but this disclosure should not be construed as being limited to those examples, and all technical ideas that are conceived by those skilled in the art who contacted our concepts and considered as implementable, and specific modes thereof should be understood as being included in this disclosure.

### Measurement Example 1: Gel Permeation Chromatography (GPC) Measurement

Chloroform was added to each of the dilactide/ε-caprolactone copolymers obtained in Synthesis Examples 1 to 3 and the biodegradable polymer solutions prepared in Examples and Comparative Examples to prepare a polymer solution in an amount of 1 mg/mL. After that, the polymer solution was allowed to pass through a 0.45 μm syringe filter (DISMIC-13HP; manufactured by ADVANTEC) to remove impurities and the like, and then a differential molecular weight distribution curve in terms of polystyrene was obtained by GPC measurement under the following conditions. From the obtained distribution curve, the weight average molecular weight was calculated, and the molecular weight corresponding to the maximum value was obtained.
Device name: Prominence (manufactured by Shimadzu Corporation)
Mobile phase: chloroform (for HPLC) (manufactured by Wako Pure Chemical Industries, Ltd.)
Flow rate: 1 mL/min
Column: TSKgel GMHHR-M (φ7.8 mm×300 mm; manufactured by Tosoh Corporation)
Guard column: TSKgel guardcolumn HHR-H (φ6.0 mm×40 mm; manufactured by Tosoh Corporation)
Detector: UV (254 nm), RI
Column, detector temperature: 35° C.
Reference material: polystyrene

### Measurement Example 2: Measurement of Crystallization Rate of Dilactide Residue by Differential Scanning Calorimetry (DSC)

The dilactide/ε-caprolactone copolymer obtained in Synthesis Examples 1 to 3 was collected in an aluminum pan, and heat of fusion was calculated by DSC method under the following conditions with a differential scanning calorimeter (EXTAR 6000; manufactured by Seiko Instruments Inc.). From the obtained value of heat of fusion, the crystallization rate was calculated by the following equation:

Crystallization rate=(Heat of fusion per unit weight of dilactide residues of dilactide/ε-caprolactone copolymer)/{(Heat of fusion per unit weight of homopolymer consisting only of dilactide residues)×(Weight fraction of dilactide residues in dilactide/ε-caprolactone copolymer)}×100
Device name: EXSTAR 6000 (manufactured by Seiko Instruments Inc.)
Temperature conditions: 25° C.→250° C. (10° C./min)→250° C. (5 min)→−70° C. (10° C./min)→250° C. (10° C./min)→250° C. (5 min)→25° C. (100° C./min) Reference material: aluminum

### Measurement Example 3: Measurement of Mole Fraction and R Value of Each Residue by Nuclear Magnetic Resonance (NMR)

The dilactide/ε-caprolactone copolymer obtained in Synthesis Examples 1 to 3 was dissolved in deuterated chloroform, and the ratios of the dilactide residues and the caprolactone residues to the dilactide/ε-caprolactone copolymer were calculated by ¹H-NMR under the following conditions. In addition, by ¹H homospin decoupling method, for a methine group of dilactide (around 5.10 ppm), an α-methylene group of ε-caprolactone (around 2.35 ppm), and an ε-methylene group (around 4.10 ppm), adjacent monomer residues were separated by a signal derived from lactide or ε-caprolactone and each peak area was quantified. From each area ratio, [AB] of the equation 1 was calculated to obtain the R value. [AB] is a mole fraction of a structure in which the dilactide residues and the caprolactone residues are adjacent, and specifically, it is a ratio of the number of A-B and B-A to the total number of A-A, A-B, B-A, and B-B.
Device name: JNM-EX270 (manufactured by JEOL Ltd.)
¹H homospin decoupling irradiation position: 1.66 ppm
Solvent: deuterated chloroform
Measurement temperature: room temperature

### Measurement Example 4: Measurement of Fiber Diameter

The tube under the condition of a spinning time of 10 minutes obtained in each Example and Comparative Example was set on a sample stage of a microscope (KH-1300, manufactured by HIROX Co., Ltd.), the surface of the tube was observed at a magnification of 500 times and photographed using the attached image analysis software “2D measure.” At the time of photographing, when the entire screen was not in focus due to the depth of the sample, depth synthesis was performed using the function of the same software. From the photographed image, 20 fibers were randomly selected, the fiber diameters were measured by distance measurement between two points using the function of the same software, and the average value thereof was taken as the fiber diameter of the fiber structure.

### Measurement Example 5: Permeation Resistance Measurement

Each of the tubes under the conditions of a spinning time of 10 minutes, 30 minutes, and 60 minutes obtained in each Example and Comparative Example was cut perpendicularly to the long axis and set on a sample stage of a microscope (KH-1300; manufactured by HIROX Co., Ltd.). The cross section of the tube was observed at a magnification of 250 times and photographed using the attached image analysis software “2D measure.” At the time of photographing, when the entire screen was not in focus due to the depth of the sample, depth synthesis was performed using the function of the same software. Five points were randomly selected from the photographed image, the thickness of each point was measured by distance measurement between two points, and the average value was taken as the thickness of the tube at each spinning time.

Each of the tubes under the conditions of a spinning time of 10 minutes, 30 minutes, and 60 minutes obtained in each Example and Comparative Example was cut to a length of 1 cm and fixated to a well in a 24-well plate (product name “Nontreat” manufactured by Falcon). Thereafter, 100 μl of fetal bovine serum (manufactured by Gibco) was added to an inner side of the tube, 1 ml of PBS (manufactured by FUJIFILM Corporation) was added to an outer side, and the tube was allowed to stand for 3 hours. Thereafter, the concentration of serum proteins in PBS was measured using a BSA measuring kit (manufactured by Invitrogen Corporation), and the total amount (Q) (ng) of serum proteins that permeated the outer side was calculated. The surface area (outer diameter×π×1 cm) of the tube was defined as S (mm²), the standing time was defined as T (s), and the protein permeation flux J (ng/mm²·s) per unit time was calculated by equation (III):

J=Q/(S×T) (III).

For each tube, the slope of the approximate straight line was calculated from a scatter diagram in which the protein permeation flux J was plotted on the vertical axis and the tube thickness d (mm) was plotted on the horizontal axis, and the permeation resistance (ng/mm³·s) was determined from the absolute value thereof.

### Measurement Example 6: Measurement of Days Required for Decomposition

As an index of the in-vivo residual time of the fiber structure, the change over days in molecular weight was measured using a film made of a polymer composition having the same composition as that of the biodegradable polymer fibers of Examples 1 and 2 and Comparative Examples 2 to 4. The biodegradable polymer solution prepared in Examples 1 and 2 and Comparative Examples 2 to 4 was transferred onto a petri dish made of “TEFLON” (registered trademark) and dried at normal pressure and room temperature for a whole day and night. A polymer film having a thickness of 0.1 mm obtained by drying the resulting material under reduced pressure was cut into a strip shape (30 mm×5 mm). Each of the cut out films was set in a well in a 6-well plate (product name “Nontreat” manufactured by Falcon), and 3 mL of PBS (manufactured by Fujifilm Corporation) was added thereto to immerse the film with PBS. The obtained material was placed in a thermostatic chamber at 37° C. and shaken under the condition of 100 rpm. PBS was replaced twice a week, 1 mg of the immersed film was cut out once a week, and the weight average molecular weight was measured by the method described in Measurement Example 1. The number of days at the time when the weight average molecular weight reached the measurement limit of 500 or less was recorded. The longer the number of days required for decomposition, the longer the in-vivo residual time.

### Synthesis Example 1: Synthesis of Dilactide/ε-Caprolactone Copolymer

_{L}-dilactide (manufactured by Corbion N.V.) in an amount of 25 g and 18.3 mL of ε-caprolactone (manufactured by Wako Pure Chemical Industries, Ltd.) were collected as monomers in a separable flask. A solution obtained by dissolving 0.05 parts by weight (in terms of tin) of tin(II) octylate (manufactured by Wako Pure Chemical Industries, Ltd.) with respect to 100 parts by weight of the total of dilactide and ε-caprolactone in 3.5 mL of toluene (super dehydrated) (manufactured by Wako Pure Chemical Industries, Ltd.) as a catalyst and 227.4 mg of hydroxypivalic acid (manufactured by Tokyo Chemical Industry Co., Ltd.) as a co-initiator were added thereto under a nitrogen atmosphere. The mixture was stirred at a stirring speed of 100 rpm for 12 hours while being heated to 140° C. to perform a copolymerization reaction, whereby a macromer solution was obtained.

To the obtained macromer solution, 1.67 g of 4,4-dimethylaminopyridinium p-toluenesulfonate (synthetic product) and 617.9 mg of 4,4-dimethylaminopyridine (manufactured by Wako Pure Chemical Industries, Ltd.) were added as catalysts. These were dissolved in 255 mL of dichloromethane (dehydrated) (manufactured by Wako Pure Chemical Industries, Ltd.) under a nitrogen atmosphere, 5.76 g of dicyclohexylcarbodiimide (manufactured by Sigma-Aldrich Co. LLC.) was added as a condensing agent, and the mixture was stirred at 25° C. and a stirring speed of 100 rpm for 18 hours to perform condensation polymerization.

To the reaction mixture, 3.0 mL of acetic acid (manufactured by Wako Pure Chemical Industries, Ltd.) and chloroform in an amount to have a dilactide/ε-caprolactone copolymer concentration of 15 wt % were added, and the mixture was stirred at 25° C. and a stirring speed of 200 rpm for 2 hours. Thereafter, the reaction mixture was added dropwise to 2.0 L of methanol in a stirred state at 300 rpm to obtain a precipitate. The obtained precipitate was dried for 18 hours to obtain a dilactide/ε-caprolactone copolymer. As a result of measuring the obtained dilactide/ε-caprolactone copolymer by the methods of Measurement Example 1, Measurement Example 2, and Measurement Example 3, the weight average molecular weight and the molecular weight corresponding to the maximum value were 240,000, the crystallization rate of the dilactide residues was 0.0%, and the R value was 0.60.

### Synthesis Example 2: Synthesis of Dilactide/ε-Caprolactone Copolymer

A macromer solution was obtained in the same manner as in Synthesis Example 1. To the obtained macromer solution, 3.0 mL of acetic acid (manufactured by Wako Pure Chemical Industries, Ltd.) and chloroform in an amount to have a dilactide/ε-caprolactone macromer concentration of 15 wt % were added, and the mixture was stirred at 25° C. and a stirring speed of 200 rpm for 2 hours. Thereafter, the reaction mixture was added dropwise to 2.0 L of methanol in a stirred state at 300 rpm to obtain a precipitate. The obtained precipitate was dried for 18 hours to obtain a dilactide/ε-caprolactone copolymer. The weight average molecular weight and the molecular weight corresponding to the maximum value of the obtained dilactide/ε-caprolactone copolymer were 60,000, the crystallization rate of the dilactide residues was 0.0%, and the R value was 0.58.

### Synthesis Example 3: Synthesis of Dilactide/ε-Caprolactone Copolymer

_{L}-dilactide (manufactured by Purac Biochem B.V.) in an amount of 50.0 g and 38.5 mL of ε-caprolactone (manufactured by Wako Pure Chemical Industries, Ltd.) were collected as monomers in a separable flask. A solution obtained by dissolving 0.1 parts by weight of tin(II) octylate (manufactured by Wako Pure Chemical Industries, Ltd.) with respect to 100 parts by weight of the total of dilactide and ε-caprolactone in 14.5 mL of toluene (super dehydrated) (manufactured by Wako Pure Chemical Industries, Ltd.) as a catalyst and an ion-exchanged water as a co-initiator in an amount to have a monomer/co-initiator ratio of 142.9 were added thereto under an argon atmosphere. The mixture was stirred at a stirring speed of 100 rpm for 1 hour while being heated to 90° C. to perform a cocatalyst reaction, and then stirred at a stirring speed of 100 rpm for 6 hours while being heated to 150° C. to perform a copolymerization reaction, whereby a crude copolymer was obtained. The obtained crude copolymer was dissolved in 100 mL of chloroform and added dropwise to 1400 mL of methanol in a stirred state to obtain a precipitate. This operation was repeated three times, and the precipitate was dried under reduced pressure at 70° C. to obtain a macromer.

The obtained macromer in an amount of 7.5 g, 0.28 g of 4,4-dimethylaminopyridinium p-toluenesulfonate (synthetic product) and 0.10 g of 4,4-dimethylaminopyridine (manufactured by Wako Pure Chemical Industries, Ltd.) as catalysts were collected in a same container. These were dissolved in dichloromethane (dehydrated) (manufactured by Wako Pure Chemical Industries, Ltd.) to have a macromonomer concentration of 30 wt % under an argon atmosphere, and the mixture was stirred under an environment of 1.3 kPa at a stirring speed of 100 rpm for two hours. A solution obtained by dissolving 0.47 g of amylene (manufactured by Tokyo Chemical Industry Co., Ltd.) in 5 mL of dichloromethane was added as a condensing agent, and the mixture was stirred at 25° C. and a stirring speed of 100 rpm for 48 hours to perform condensation polymerization.

To the reaction mixture, 30 mL of chloroform was added and stirred at 25° C. and stirring speed of 200 rpm for two hours. Thereafter, the reaction mixture was added dropwise to 2.0 L of methanol in a stirred state at 300 rpm to obtain a precipitate. This precipitate was dissolved in 50 mL of chloroform and added dropwise to 500 mL of methanol in a stirred state at 300 rpm to obtain a precipitate again. This operation was repeated twice to obtain a dilactide/ε-caprolactone copolymer as a precipitate. The weight average molecular weight and the molecular weight corresponding to the maximum value of the obtained dilactide/ε-caprolactone copolymer were 100,000, the crystallization rate of the dilactide residues was 0.0%, and the R value was 0.78.

### Example 1

The dilactide/ε-caprolactone copolymer obtained in Synthesis Example 1 as a high molecular weight biodegradable polymer in an amount of 1 g and 2 g of the dilactide/ε-caprolactone copolymer obtained in Synthesis Example 2 as a low molecular weight biodegradable polymer were collected and mixed while being dissolved in 10 mL of chloroform to obtain a biodegradable polymer solution. The weight average molecular weight of the obtained biodegradable polymer solution was measured by the method described in Measurement Example 1.

The obtained biodegradable polymer solution was collected in a 5 mL syringe (Terumo Corporation), and an 18G needle (MECC Co., Ltd.) designed for a spinning device NANON-3 of MECC Co., Ltd. was attached. A syringe containing the biodegradable polymer solution and a φ4 mm mandrel collector were set in NANON-3, and spinning was performed by an electrospinning method. The spinning conditions were as follows: spinning distance: 17 cm, spinning voltage: 25 kV, spinning speed: 1 mL/hour, rotation speed: 50 rpm, spinning amplitude: 15 cm, spinning time: 10 minutes, 30 minutes, and 60 minutes. After the spinning, the fiber structure was removed from the mandrel collector to obtain a tube having a nonwoven fabric-like structure. The fiber diameter of the tube obtained under the condition of a spinning time of 10 minutes was measured by the method described in Measurement Example 4. For each of the tubes obtained under the conditions of a spinning time of 10 minutes, 30 minutes, and 60 minutes, the permeation resistance was calculated by the method described in Measurement Example 5.

The biodegradable polymers used and the evaluation results are shown in Table 1.

### Example 2

A tube was produced in the same manner as in Example 1 except that 1 g of the dilactide/ε-caprolactone copolymer obtained in Synthesis Example 2 was used as the low molecular weight biodegradable monomer. The evaluation results are shown in Table 1.

### Comparative Example 1

A tube was produced in the same manner as in Example 1 except that 2 g of the dilactide/ε-caprolactone copolymer obtained in Synthesis Example 1 was used as the high molecular weight biodegradable polymer, and the low molecular weight biodegradable monomer was not used. The evaluation results are shown in Table 1.

### Comparative Example 2

A tube was produced in the same manner as in Example 1 except that the low molecular weight biodegradable monomer was not used. The evaluation results are shown in Table 1.

### Comparative Example 3

A Tube was produced in the same manner as in Example 1 except that the high molecular weight biodegradable monomer was not used and 2 g of the dilactide/ε-caprolactone copolymer obtained in Synthesis Example 3 was used as the low molecular weight biodegradable polymer. The evaluation results are shown in Table 1.

### Comparative Example 4

A Tube was produced in the same manner as in Example 1 except that the high molecular weight biodegradable monomer was not used and 3 g of the dilactide/ε-caprolactone copolymer obtained in Synthesis Example 3 was used as the low molecular weight biodegradable polymer. The evaluation results are shown in Table 1.

### Example 3

A polylactic acid (product name “PURASORB PL24,” manufactured by Coribion N.V., weight average molecular weight and molecular weight corresponding to maximum value are 240,000) in an amount of 2 g as the high molecular weight biodegradable polymer and 2.5 g of polylactic acid (product name “PURASORB PL0.2,” manufactured by Purac Biochem B.V., weight average molecular weight and molecular weight corresponding to maximum value are 2,000) as the low molecular weight biodegradable polymer were collected, and mixed while being dissolved in 10 mL of chloroform to obtain a biodegradable polymer solution. The weight average molecular weight of the obtained biodegradable polymer solution was measured by the method described in Measurement Example 1.

The obtained biodegradable polymer solution was collected in a 5 mL syringe (Terumo Corporation), and a 22G needle (MECC Co., Ltd.) designed for a spinning device NANON-3 of MECC Co., Ltd. was attached. A syringe containing the biodegradable polymer solution and a φ4 mm mandrel collector were set in NANON-3, and spinning was performed by an electrospinning method. The spinning conditions were as follows: spinning distance: 15 cm, spinning voltage: 22 kV, spinning speed: 3 mL/hour, rotation speed: 50 rpm, spinning amplitude: 15 cm, spinning time: 10 minutes, 30 minutes, and 60 minutes. After the spinning, the fiber structure was removed from the mandrel collector to obtain a tube having a nonwoven fabric-like structure. The fiber diameter of the tube obtained under the condition of a spinning time of 10 minutes was measured by the method described in Measurement Example 4. For each of the tubes obtained under the conditions of a spinning time of 10 minutes, 30 minutes, and 60 minutes, the permeation resistance was calculated by the method described in Measurement Example 5.

The biodegradable polymers used and the evaluation results are shown in Table 2.

### Example 4

A tube was produced in the same manner as in Example 3 except that 2.0 g of polylactic acid (product name “PLLA,” manufactured by BMG Inc., weight average molecular weight and molecular weight corresponding to the maximum value are 320,000) was used as the high molecular weight biodegradable polymer, and 2.5 g of polylactic acid having a weight average molecular weight and a maximum value corresponding to 6,000 from GPC measurement, obtained by hydrolyzing a polylactic acid (product name: “PLA10,” Wako Pure Chemical Industries, Ltd.) was used as the low molecular weight biodegradable polymer. The evaluation results are shown in Table 2.

### Comparative Example 5

A tube was produced in the same manner as in Example 3 except that the low molecular weight biodegradable polymer was not used. The evaluation results are shown in Table 2.

### Comparative Example 6

A tube was produced in the same manner as in Example 3 except that 4.5 g of polylactic acid (product name “PURASORB PL24,” manufactured by Coribion N.V., weight average molecular weight and molecular weight corresponding to the maximum value are 240,000) was used as the high molecular weight biodegradable polymer, and the low molecular weight biodegradable monomer was not used. The evaluation results are shown in Table 2.

### Comparative Example 7

A tube was produced in the same manner as in Example 3 except that 4.5 g of polylactic acid (product name “PURASORB PL12,” manufactured by Coribion N.V., weight average molecular weight and molecular weight corresponding to the maximum value are 120,000) was used as the high molecular weight biodegradable polymer, and the low molecular weight biodegradable monomer was not used. The evaluation results are shown in Table 2.

### Comparative Example 8

A tube was produced in the same manner as in Example 4 except that 2.0 g of polylactic acid (product name “PLLA,” manufactured by BMG Inc., weight average molecular weight and molecular weight corresponding to the maximum value are 320,000) was used as the high molecular weight biodegradable polymer, and the low molecular weight biodegradable polymer was not used. The evaluation results are shown in Table 2.

### Example 5

A tube was produced in the same manner as in Example 3 except that 2.0 g of polylactic acid (product name “PURASORB PL24,” manufactured by Coribion N.V., weight average molecular weight and molecular weight corresponding to the maximum value are 240,000) was used as the high molecular weight biodegradable polymer, and 1.0 g of polylactic acid having a weight average molecular weight and a maximum value corresponding to 200 from GPC measurement, obtained by hydrolyzing a polylactic acid (product name: “PLA10,” Wako Pure Chemical Industries, Ltd.) was used as the low molecular weight biodegradable polymer. The evaluation results are shown in Table 2.

### Example 6

Poly(dilactide/glycolic acid copolymer) (product name: PGLA (10:90), manufactured by BMG Inc., CGA:CLA=10:90, weight average molecular weight and the molecular weight corresponding to the maximum value are 260,000) in an amount of 2.0 g as the high molecular weight biodegradable polymer and 1.0 g of poly(dilactide/glycolic acid copolymer) having a weight average molecular weight and a maximum value corresponding to 10,000 from GPC measurement, obtained by hydrolyzing a poly(dilactide/glycolic acid copolymer) (product name: PLGA5020, Wako Pure Chemical Industries, Ltd., currently manufactured by FUJIFILM Wako Pure Chemical Corporation) as the low molecular weight biodegradable polymer were collected and mixed while being dissolved in 10 mL of chloroform to obtain a biodegradable polymer solution. The weight average molecular weight of the obtained biodegradable polymer solution was measured by the method described in Measurement Example 1. A tube was produced in the same manner as in Example 3. The evaluation results are shown in Table 3.

### Example 7

A tube was produced in the same manner as in Example 3 except that 4.0 g of poly(dilactide/glycolic acid copolymer) having a weight average molecular weight and a maximum value corresponding to 10,000 from GPC measurement, obtained by hydrolyzing a poly(dilactide/glycolic acid copolymer) (product name: PLGA5020, Wako Pure Chemical Industries, Ltd., currently manufactured by FUJIFILM Wako Pure Chemical Corporation) was used as the low molecular weight biodegradable polymer. The evaluation results are shown in Table 3.

### Comparative Example 9

A tube was produced in the same manner as in Example 6 except that the low molecular weight biodegradable polymer was not used. The evaluation results are shown in Table 3.

### Comparative Example 10

A tube was produced in the same manner as in Example 6 except that 3.0 g of poly(dilactide/glycolic acid copolymer) (product name “PGLA (10:90),” manufactured by BMG Inc., CGA:CLA=10:90, weight average molecular weight and the molecular weight corresponding to the maximum value were 260,000) was used as the high molecular weight biodegradable polymer, and the low molecular weight biodegradable polymer was not used. The evaluation results are shown in Table 3.

TABLE 1

| | High molecular weight | | Low molecular weight | | | Evaluation results | | |
|---|---|---|---|---|---|---|---|---|
| | biodegradable polymer | | biodegradable polymer | | | | | Days |
| | | Solution | | Solution | Weight average | Fiber | Permeation | required for |
| | Molecular | concentration | Molecular | concentration | molecular | diameter | resistance | decomposition |
| | weight peak | g/ml | weight peak | g/ml | weight | μm | ng/mm³ · s | Days |
| Example 1 | 240,000 | 0.10 | 60,000 | 0.20 | 120,000 | 5.2 | 45.7 | 202 |
| Example 2 | 240,000 | 0.10 | 60,000 | 0.10 | 150,000 | 4.1 | 49.8 | 202 |
| Comparative | 240,000 | 0.20 | — | — | 240,000 | Not spun | — | — |
| Example 1 | | | | | | | | |
| Comparative | 240,000 | 0.10 | — | — | 240,000 | 2.8 | 54.9 | 202 |
| Example 2 | | | | | | | | |
| Comparative | — | — | 100,000 | 0.20 | 100,000 | 3.1 | 53.8 | 170 |
| Example 3 | | | | | | | | |
| Comparative | — | — | 100,000 | 0.30 | 100,000 | 4.5 | 48.3 | 170 |
| Example 4 | | | | | | | | |

TABLE 2

| | High molecular weight | | Low molecular weight | | | | |
|---|---|---|---|---|---|---|---|
| | biodegradable polymer | | biodegradable polymer | | | Evaluation results | |
| | | Solution | | Solution | Weight average | Fiber | Permeation |
| | Molecular | concentration | Molecular | concentration | molecular | diameter | resistance |
| | weight peak | g/ml | weight peak | g/ml | weight | μm | ng/mm³ · s |
| Example 3 | 240,000 | 0.20 | 2,000 | 0.25 | 110,000 | 3.9 | 50.5 |
| Example 4 | 320,000 | 0.20 | 6,000 | 0.25 | 145,555 | 4.1 | 49.8 |
| Example 5 | 240,000 | 0.20 | 200 | 0.10 | 160,000 | 9.1 | 30.7 |
| Comparative | 240,000 | 0.20 | — | — | 240,000 | 2.9 | 54.3 |
| Example 5 | | | | | | | |
| Comparative | 240,000 | 0.45 | — | — | 240,000 | Not spun | — |
| Example 6 | | | | | | | |
| Comparative | — | — | 120,000 | 0.45 | 120,000 | 3.4 | 52.4 |
| Example 7 | | | | | | | |
| Comparative | 320000 | 0.20 | — | — | 320,000 | Not spun | — |
| Example 8 | | | | | | | |

TABLE 3

| | High molecular weight | | Low molecular weight | | | | |
|---|---|---|---|---|---|---|---|
| | biodegradable polymer | | biodegradable polymer | | | Evaluation results | |
| | | Solution | | Solution | Weight average | Fiber | Permeation |
| | Molecular | concentration | Molecular | concentration | molecular | diameter | resistance |
| | weight peak | g/ml | weight peak | g/ml | weight | μm | ng/mm³ · s |
| Example 6 | 240,000 | 0.20 | 10,000 | 0.10 | 160,000 | 6.8 | 39.5 |
| Example 7 | 240,000 | 0.20 | 10,000 | 0.40 | 87,000 | 10.8 | 24.2 |
| Comparative | 240,000 | 0.20 | — | — | 240,000 | 2.9 | 54.4 |
| Example 9 | | | | | | | |
| Comparative | 240,000 | 0.30 | — | — | 240,000 | Not spun | — |
| Example 10 | | | | | | | |

1-8. (canceled)

9. A fiber structure comprising a biodegradable polymer fiber, the fiber structure having two or more peaks in a molecular weight distribution obtained by GPC measurement of the biodegradable polymer.

10. The fiber structure according to claim 9, the fiber structure having one or more peaks in each of a region of 100,000 or less of molecular weight and a region of more than 100,000 of molecular weight in the molecular weight distribution obtained by GPC measurement of the biodegradable polymer.

11. The fiber structure according to claim 9, wherein the biodegradable polymer fiber has a fiber diameter of 3 μm or more and has a nonwoven fabric-like structure.

12. The fiber structure according to claim 9, wherein the biodegradable polymer is a biodegradable polyester.

13. The fiber structure according to claim 9, the fiber structure having a peak in a region of 100 to 70,000 of molecular weight and a peak in a region of 200,000 or more of molecular weight.

14. The fiber structure according to claim 12, wherein the biodegradable polymer is polylactic acid, polycaprolactone, polyglycolic acid, or a copolymer thereof.

15. The fiber structure according to claim 14, wherein the biodegradable polymer is a dilactide/ε-caprolactone copolymer satisfying (1) and (2):
(1) an R value represented by equation (I):
R=[AB]/(2[A][B])×100 (I)
[A]: mole fraction (%) of dilactide residues in the dilactide/ε-caprolactone copolymer;
[B]: mole fraction (%) of ε-caprolactone residues in the dilactide/ε-caprolactone copolymer; and
[AB]: mole fraction (%) of a structure in which the dilactide residues and the ε-caprolactone residues are adjacent (A-B and B-A) in the dilactide/ε-caprolactone copolymer,
is 0.45 to 0.99; and
(2) a crystallization rate of at least either one of the dilactide residues and the ε-caprolactone residues is less than 14%.

16. A method of producing the fiber structure according to claim 9, comprising forming a fiber from a solution of the biodegradable polymer by an electrospinning method.
